(19) United States
(12) Patent Application Publication
(10) Pub. No.: US 2026/0203348 A1
(43) Pub. Date: Jul. 16, 2026

(54) COMPUTER-IMPLEMENTED METHOD OF SONG RECOMMENDATION, ELECTRONIC DEVICE AND COMPUTER-READABLE STORAGE MEDIUM

(71) Applicant: LINKPLAY TECHNOLOGY INC. NANJING, Nanjing (CN)

(72) Inventors: Yuanfei PEI, Nanjing (CN); Lifeng ZHAO, Nanjing (CN); Qi WANG, Nanjing (CN)

(73) Assignee: LINKPLAY TECHNOLOGY INC. NANJING, Nanjing (CN)

(21) Appl. No.: 19/565,846

(22) Filed: Mar. 13, 2026

Related U.S. Application Data
(63) Continuation of application No. PCT/CN2025/080403, filed on Mar. 4, 2025.

(30) Foreign Application Priority Data
Oct. 21, 2024 (CN) 202411469120.6

(51) Int. Cl. G06F 16/683; G06F 16/632; G06F 16/635; G06F 16/638

(52) U.S. Cl. CPC G06F 16/685; G06F 16/634; G06F 16/637; G06F 16/639

(57) ABSTRACT

A computer-implemented method of song recommendation includes: obtaining real-time user interaction data and historical user usage data of songs; generating, based on the real-time user interaction data and the historical user usage data, a target model, where the target model is a model representing user preferences; obtaining a target music feature and a set of candidate songs similar to a currently playing song; where the target music feature is a feature obtained by fusing multimodal music features; and generating, based on the target model and the target music feature, a dynamic queue of the set of candidate songs, and obtaining a set of to-be-played song.

### CROSS-REFERENCE TO RELATED APPLICATIONS

This application is a continuation of International Application No. PCT/CN2025/080403, filed on Mar. 4, 2025, which claims priority to Chinese Patent Application No. 202411469120.6, filed on Oct. 21, 2024. The disclosures of the above-mentioned applications are hereby incorporated by reference in their entireties.

### TECHNICAL FIELD

The present disclosure relates to the field of multimedia technology, in particular to a computer-implemented method of song recommendation, an electronic device and a storage medium.

### BACKGROUND

Along with the increasing demand from users for listening to music, existing music playback platforms adopt a simple shuffle playback manner or collaborative filtering-based recommendation manner to play songs. However, the simple shuffle playback manner or collaborative filtering-based recommendation manner, due to such factors as lack of diversity or omission of data analysis objects, results in low accuracy of the played songs, meaning low user personalization, which in turn leads to a low personalized music listening experience for users.

### SUMMARY

In a first aspect, the embodiments of the present disclosure provide a computer-implemented method of song recommendation, including: obtaining real-time user interaction data and historical user usage data of songs; generating, based on the real-time user interaction data and the historical user usage data, a target model, where the target model is a model representing user preferences; obtaining a target music feature and a set of candidate songs similar to a currently playing song; where the target music feature is a feature obtained by fusing multimodal music features; and generating, based on the target model and the target music feature, a dynamic queue of the set of candidate songs, and obtaining a set of to-be-played song.

In a second aspect, the embodiments of the present disclosure provide an electronic device, including a processor and a memory, where the memory has stored thereon machine-executable instructions executable by the processor, and the machine-executable instructions, when executed by the processor, cause the processor to implement following steps: obtaining real-time user interaction data and historical user usage data of songs; generating, based on the real-time user interaction data and the historical user usage data, a target model, where the target model is a model representing user preferences; obtaining a target music feature and a set of candidate songs similar to a currently playing song; where the target music feature is a feature obtained by fusing multimodal music features; and generating, based on the target model and the target music feature, a dynamic queue of the set of candidate songs, and obtaining a set of to-be-played song.

In a third aspect, the embodiments of the present disclosure provide a computer-readable storage medium having stored thereon computer-executable instructions, where the computer-executable instructions, when called and executed by a processor, cause the processor to implement the following steps: obtaining real-time user interaction data and historical user usage data of songs; generating, based on the real-time user interaction data and the historical user usage data, a target model, where the target model is a model representing user preferences; obtaining a target music feature and a set of candidate songs similar to a currently playing song; where the target music feature is a feature obtained by fusing multimodal music features; and generating, based on the target model and the target music feature, a dynamic queue of the set of candidate songs, and obtaining a set of to-be-played song.

The additional features and advantages of the present disclosure will be given in the following description, and part of which may become apparent, or may be understood through the implementation of the present disclosure. The objectives and other advantages of the present disclosure are achieved and obtained by the parts particularly pointed out in the description, claims, and drawings.

To make the objectives, features and advantages of the present disclosure more apparent and understandable, preferred embodiments are particularly exemplified below and described in detail as follows with reference to the accompanying drawings.

### BRIEF DESCRIPTION OF THE DRAWINGS

In order to illustrate the technical solutions of the embodiments of the present disclosure or the related art in a clearer manner, the drawings required for the description of the embodiments of the present disclosure or the related art will be described hereinafter briefly. Apparently, the following drawings merely relate to some embodiments of the present disclosure, and based on these drawings, a person of ordinary skill in the art may obtain other drawings without any creative effort.

FIG. 1 is a schematic view showing an electronic device according to the embodiments of the present disclosure.

FIG. 2 is a schematic diagram of a computer-implemented method of song recommendation according to the embodiments of the present disclosure.

FIG. 3 is another schematic diagram of the computer-implemented method of song recommendation according to the embodiments of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings. Apparently, the following embodiments merely relate to a part of, rather than all of, the embodiments of the present disclosure, and based on these embodiments, a person skilled in the art may, without any creative effort, obtain the other embodiments, which also fall within the scope of the present disclosure.

The embodiments of the present disclosure provide a computer-implemented method of song recommendation, an electronic device and a storage medium, which may be applied in, any computer-implemented scenario for song recommendation, especially in the scenario of song recommendation on a music playback platform.

In one implementation, the computer-implemented method of song recommendation may be run on a terminal device or a server. The terminal device may be a local terminal device. When the computer-implemented method of song recommendation is run on a server, this method may be implemented and executed based on a cloud interaction system, where the cloud interaction system includes a server and a client device.

The embodiments of the present disclosure further provide an electronic device, including: a processor, and a memory, where the memory has stored thereon machine-executable instructions that are capable of being executed by the processor, and the processor is configured to execute the machine-executable instructions. The electronic device may be a server or a terminal device.

As shown in FIG. 1, the electronic device includes a processor 100 and a memory 101. The memory 101 stores machine-executable instructions that can be executed by the processor 100, and the processor 100 is configured to execute the machine-executable instructions.

Furthermore, the electronic device in FIG. 1 further includes a bus 102 and a communication interface 103, and the processor 100, the communication interface 103 and the memory 101 are connected via the bus 102.

In some embodiments, the memory 101 may include a high-speed random access memory (RAM), or a non-volatile memory (non-volatile memory), for example, at least one disk storage. The communication connection between the system network element and at least one other network element is realized through at least one communication interface 103 (which may be wired or wireless), and the Internet, wide area network, local area network, metropolitan area network, etc. may be used. The bus 102 may be an Industry Standard Architecture (ISA) bus, a Peripheral Component Interconnect (PCI) bus, or an Extended Industry Standard Architecture (EISA) bus, etc. The bus may be categorized as an address bus, a data bus, a control bus, etc. For ease of representation, only one bidirectional arrow is used in FIG. 1, but it does not mean that there is only one bus or one type of bus.

The processor 100 may be an integrated circuit with signal processing capability. In the implementation process, the various steps of the above method may be implemented by an integrated logic circuit of the processor 100 in hardware form or implemented by instructions in the form of software in the processor 100. The processor 100 may be a general-purpose processor, including a central processing unit (CPU), a network processor (NP), etc. The processor 100 may also be a digital signal processor (DSP), an application specific integrated circuit (ASIC), a field programmable gate array (FPGA) or any other programmable logic device, discrete gate or transistor logic device, discrete hardware component. Various methods, steps and logic block diagrams in the embodiments of the present disclosure may be implemented or carried out. The general processor may be a micro-processor or any conventional processor, etc. The steps of the method in the embodiments of the present disclosure may be directly implemented by a hardware decoding processor, or implemented by a combination of hardware and software modules in the decoding processor. The software modules may be located in a storage medium well-known in the art, such as a random access memory, a flash memory, a read-only memory, a programmable read-only memory, or an electrically erasable programmable memory, a register. The storage medium is located in the memory 101, and the processor 100 reads the information in the memory 101 and finishes the following method steps in combination with its hardware: obtaining real-time user interaction data and historical user usage data of songs; generating, based on the real-time user interaction data and the historical user usage data, a target model, where the target model is a model representing user preferences; obtaining a target music feature and a set of candidate songs similar to a currently playing song; where the target music feature is a feature obtained by fusing multimodal music features; and generating, based on the target model and the target music feature, a dynamic queue of the set of candidate songs, and obtaining a set of to-be-played song.

In one implementation, the obtaining real-time user interaction data and historical user usage data of songs includes: obtaining original real-time interaction data and original historical behavior data of a target user for songs; performing data cleaning and standardization processing on the original real-time interaction data, and obtaining pre-processed original real-time interaction data; generating, based on the pre-processed original real-time interaction data, an interaction matrix; where the interaction matrix is used to indicate implicit scores of the songs from the target user; and performing data cleaning and standardization processing on the original historical behavior data, and obtaining the historical user usage data.

In one implementation, generating the target model based on the real-time user interaction data and the historical user usage data includes: generating a first model based on the real-time user interaction data, where the first model is used to indicate the distribution of song topics that the user is interested in; generating a second model based on the historical user usage data, where the second model is used to predict a song preferred by the user; obtaining associated data of the songs, where the associated data is used to indicate a factor that influences a degree of the user's interest in a song; generating a third model based on the associated data, where the third model is a model of context correlation that influences the degree of interest in the song; and determining the target model based on the first model, the second model and the third model.

In one implementation, obtaining the target music feature and the set of candidate songs similar to the currently playing song includes: performing multimodal music feature extraction on the real-time user interaction data, the historical user usage data, and a preset song database, and obtaining the multimodal music features; fusing the multimodal music features based on a preset attention mechanism, and obtaining the target music feature; and obtaining the currently playing song, performing a search on the preset song database based on the currently playing song and preset search algorithms, and obtaining the set of candidate songs.

In one implementation, performing multimodal music feature extraction on the real-time user interaction data, the historical user usage data and the preset song database and obtaining the multimodal music features includes: extracting an audio feature of a song from the real-time user interaction data, the historical user usage data and the preset song database through a preset feature extraction model, and obtaining a target audio feature, where the feature extraction model includes at least one type of extraction algorithm; extracting a lyric semantic feature of the song from the real-time user interaction data, the historical user usage data and the preset song database through a preset language model, and obtaining a target lyric semantic feature; extracting metadata of the song from the real-time user interaction data, the historical user usage data and the preset song database through a preset data integration model, performing metadata integration, and obtaining target metadata; and determining the target audio feature, the target lyric semantic feature and the target metadata as the multimodal music features.

In one implementation, performing the search on the preset song database based on the currently playing song and the preset search algorithms and obtaining the set of candidate songs includes: performing multimodal music feature extraction on the currently playing song, and obtaining a current music feature; performing a search on the preset song database based on the current music feature using a first search algorithm and a second search algorithm in the preset search algorithms, and obtaining a first set of song and a second set of song; performing a search on the preset song database based on the current music feature using a third search algorithm in the preset search algorithms, and obtaining a third set of song; where a search level of the third search algorithm is higher than that of each of the first search algorithm and the second search algorithm; fusing the first set of song and the second set of song, and obtaining a fused set of song; and filtering the fused set of song through the third set of song, and obtaining the set of candidate songs.

In one implementation, generating the dynamic queue of the set of candidate songs based on the target model and the target music feature and obtaining the set of to-be-played song includes: calculating, based on the target model and the target music feature, an overall score corresponding to each candidate song in the set of candidate songs; sorting candidate songs in the set of candidate songs according to the overall score, and obtaining a candidate song sequence; filtering, based on a preset selection algorithm, the candidate song sequence, and obtaining a filtered candidate song sequence; and generating, based on a preset recommendation algorithm, the dynamic queue of the filtered candidate song sequence, and obtaining the set of to-be-played song.

In one implementation, the following is further implemented: subsequent to generating the dynamic queue of the set of candidate songs based on the target model and the target music feature and obtaining the set of to-be-played song, obtaining feedback information about the set of to-be-played song; and updating, based on the feedback information and a preset learning algorithm, a recommendation strategy and a model parameter of the target model in real time.

In one implementation, obtaining feedback information about the set of to-be-played song includes: obtaining user evaluation information about the set of to-be-played song; monitoring user playback behavior data of the set of to-be-played song in real time; predicting a playback duration of the set of to-be-played song through a preset analysis model based on the user playback behavior data; and determining the user evaluation information and the playback duration as the feedback information about the set of to-be-played song.

In one implementation, the following is further implemented: providing, through a terminal device, a graphical user interface; where the graphical user interface includes a plurality of sets of controls, the plurality of sets of controls is configured to obtain the user evaluation information about the set of to-be-played song; and the user evaluation information includes a plurality of types of feedback information, and one set of controls corresponds to one type of feedback information.

In one implementation, the following is further implemented: caching real-time user interaction data and historical user usage data of songs through a preset multi-level caching mechanism, and managing data in the cache through a preset management algorithm.

In one implementation, the following is further implemented: performing management and control on the real-time user interaction data, the historical user usage data, the target model, the target music feature and/or the set of to-be-played songs through a preset master-slave replication mechanism and a failover mechanism.

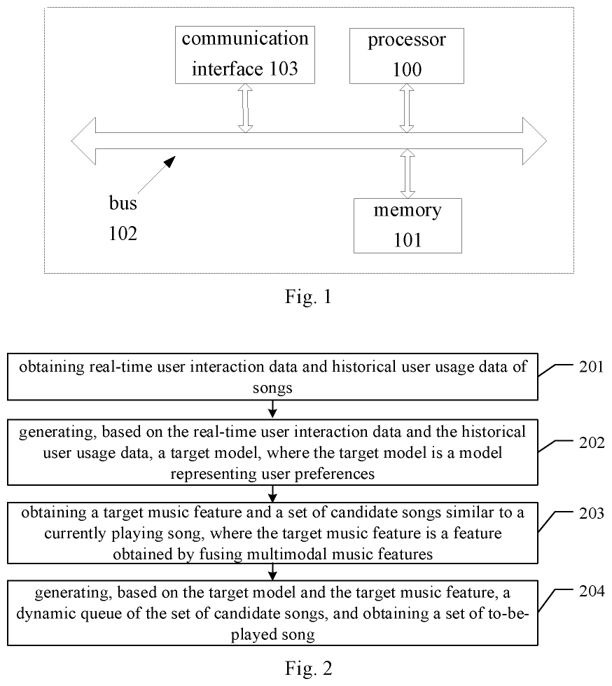

To facilitate technical comprehension, the specific process of the embodiments of the present disclosure is described below. As shown in FIG. 2, the computer-implemented method of song recommendation according to the embodiments of the present disclosure includes the following steps.

Step 201, obtaining real-time user interaction data and historical user usage data of songs.

In one implementation, real-time interaction data of songs for a target user may be obtained in real-time through a preset real-time transmission protocol (where the real-time transmission protocol is a protocol for implementing full-duplex communication between a client and a server, for example, a message queue), and the real-time interaction data is processed through a preset real-time database (where the real-time database is a database for processing a large amount of real-time written-in data) or a preset stream processing engine (where the stream processing engine is an engine for cleaning, aggregating and analyzing real-time data streams), so as to obtain the real-time user interaction data. This ensures the real-time performance and reliability of the real-time user interaction data.

In one implementation, the historical user usage data includes, but is not limited to, historical user behavior data and historical user interaction data. The historical user usage data is user usage data within a preset time period before a time corresponding to the real-time user interaction data.

In one implementation, after obtaining the real-time interaction data and historical usage data of the songs, quality monitoring may be performed on the real-time interaction data and historical usage data through a preset data quality monitoring system, and a result of the quality monitoring may be visualized through a preset monitoring tool in the data quality monitoring system. According to the result of the quality monitoring, the real-time interaction data and historical usage data are determined as the real-time user interaction data and historical user usage data, or, the real-time interaction data and historical usage data are re-acquired until the result of the quality monitoring meets a preset condition. This improves the accuracy and reliability of the real-time user interaction data and historical user usage data.

The real-time user interaction data and historical user usage data of songs are obtained with explicit user authorization, and the obtained real-time user interaction data and historical user usage data comply with relevant laws and regulations and user privacy policies.

Step 202, generating, based on the real-time user interaction data and the historical user usage data, a target model, where the target model is a model representing user preferences.

In one implementation, the target model may be a model with a multi-layer (multi-level) structure, layers are connected with each other through weight matrices. The target model is configured to analyze user preferences based on multiple types of features. The target model may also include at least one model, and each model is configured to analyze user preferences based on one type of feature. The target model is applicable to feature analysis with rich data types.

In one implementation, the real-time user interaction data is categorized to obtain categorized real-time interaction data, feature extraction is performed on the categorized real-time interaction data to obtain a plurality of categories of first features, and the plurality of categories of first features are fused to obtain a first fusion feature. The historical user usage data is categorized to obtain categorized historical usage data, feature extraction is performed on the categorized historical usage data to obtain a plurality of categories of second features, and the plurality of categories of second features are fused to obtain a second fusion feature. A target model is generated based on the first fusion feature and the second fusion feature. Through categorization and multi-category fusion, the accuracy of feature extraction is improved, thereby improving the reliability of the target model.

Step 203, obtaining a target music feature and a set of candidate songs similar to a currently playing song, where the target music feature is a feature obtained by fusing multimodal music features.

In one implementation, music feature extraction is performed on the real-time user interaction data, the historical user usage data and songs in a preset song database to obtain the target music feature; or, music feature extraction is performed on songs in a preset song database to obtain the target music feature.

In one implementation, when obtaining the target music feature, the following may be implemented: performing music feature extraction on the songs in the preset song database based on multiple preset feature extraction models, to obtain music features respectively corresponding to the multiple feature extraction models, where the multiple feature extraction models correspond to different priorities; performing multi-level verification, screening, and fusion on the music features corresponding to the multiple feature extraction models according to the priorities of the multiple feature extraction models, to obtain the target music feature, so as to improve the diversity and accuracy of the target music feature.

In one implementation, when obtaining the set of candidate songs similar to the currently playing song, it may perform a search on the preset song database based on the currently playing song and preset search algorithms, and obtain the set of candidate songs. Specifically, keyword extraction is performed on the currently playing song to obtain a target keyword. Music feature extraction is performed on the currently playing song to obtain current music features. A keyword corresponding to the target keyword is determined from a preset song keyword database to obtain a similar keyword. Music features corresponding to the current music features are determined from a preset music feature database to obtain similar music features. A search is performed on the preset song database based on the target keyword, similar keyword, current music features, similar music features, a preset first search algorithm and a preset second search algorithm, to obtain the set of candidate songs. By using diverse factors such as the target keyword, similar keyword, current music features, similar music features for search, the accuracy of search is improved, thereby improving the accuracy and reliability of the set of candidate songs.

Specifically, when performing the search on the preset song database based on the target keyword, similar keyword, current music features, similar music features, the preset first search algorithm and the preset second search algorithm to obtain the set of candidate songs, the following may be implemented: performing a search on the preset song database based on the preset first search algorithm, the target keyword and the similar keyword to obtain a first set of song; performing a search on the preset song database based on the preset second search algorithm, the current music features and the similar music features to obtain a second set of song; and merging the first set of song and the second set of song to obtain the set of candidate songs. Through the keywords and corresponding search algorithm, as well as music features and corresponding search algorithm, the efficiency and accuracy of search can be greatly and effectively improved, thereby greatly improving the accuracy and reliability of the set of candidate songs.

Step 204, generating, based on the target model and the target music feature, a dynamic queue of the set of candidate songs, and obtaining a set of to-be-played songs.

In one implementation, it may sort the set of candidate songs based on the target model and the target music feature to obtain a sorted set of candidate songs, and generate a dynamic queue of the sorted set of candidate songs based on a preset queue structure to obtain the set of to-be-played songs.

In one implementation, when sorting the set of candidate songs based on the target model and the target music feature to obtain the sorted set of candidate songs, the following may be implemented: calculating a similarity between the target music feature and each candidate song in the set of candidate songs; sorting the candidate songs in the set of candidate songs in descending order of similarity to obtain a first candidate song sequence; performing score prediction on each candidate song in the first candidate song sequence based on the target model to obtain a score of each candidate song; and sorting songs in the first candidate song sequence in descending order of the scores to obtain the sorted set of candidate songs. Through multi-level sorting, post-sorting verification is achieved, which improves sorting accuracy, thereby improving the accuracy, validity, and usability of the sorted set of candidate songs.

In one implementation, when generating the dynamic queue of the sorted set of candidate songs based on the preset queue structure to obtain the set of to-be-played song, the following may be implemented: performing selection on the sorted set of candidate songs based on a length of the preset queue structure to obtain a selected set of candidate songs and an unselected set of candidate songs; writing the selected set of candidate songs into the queue structure to obtain the set of to-be-played song, and caching the unselected set of candidate songs. By generating the dynamic sequence, effective playback of each song in the set of to-be-played song is achieved, which facilitates real-time adjustment of the set of to-be-played song, improves the reliability of the set of to-be-played song, and thereby enhances the user's personalized music listening experience.

In one implementation, after generating the dynamic queue of the sorted set of candidate songs based on the preset queue structure to obtain the set of to-be-played song, this method further includes: obtaining a target song in the set of to-be-played song, where the target song is a skipped song; determining a song similar to the target song from the cached unselected set of candidate songs to obtain a set of to-be-filtered song; removing the set of to-be-filtered song from the unselected set of candidate songs, so as to obtain a filtered unselected set of songs; and writing the filtered unselected set of songs sequentially into a queue of the set of to-be-played song based on the sorting of the songs. By filtering the unselected set of candidate songs based on the song skipped during the playback of the set of to-be-played song, optimization of the dynamic song queue based on user behavior is achieved, which can greatly improve the accuracy and reliability of the recommendation of the set of to-be-played song, thereby greatly enhancing the user's personalized music listening experience.

In this embodiment, the dynamic queue of the set of candidate songs similar to the currently playing song is generated according to a target model, which is generated based on the real-time user interaction data and the historical user usage data, and the target music feature, so as to enhance the diversification of data analysis factors for song recommendation, realize intelligent dynamic adjustment of the music playback queue, provide a user with a highly personalized and dynamically responsive music playback experience, improve the accuracy of played songs, and thereby enhance the user's personalized music listening experience.

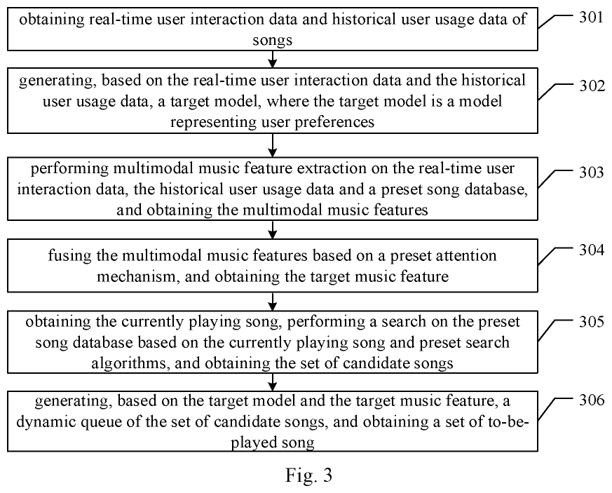

Please refer to FIG. 3, the computer-implemented method of song recommendation according to the embodiments of the present disclosure includes the following steps.

Step 301, obtaining real-time user interaction data and historical user usage data of songs.

In one implementation, when obtaining real-time user interaction data and historical user usage data of songs, the following may be implemented: obtaining original real-time interaction data and original historical behavior data of a target user for songs; performing data cleaning and standardization processing on the original real-time interaction data, and obtaining pre-processed original real-time interaction data; generating, based on the pre-processed original real-time interaction data, an interaction matrix; where the interaction matrix is used to indicate implicit scores of the songs from the target user; and performing data cleaning and standardization processing on the original historical behavior data, and obtaining the historical user usage data.

In one implementation, when performing data cleaning and standardization processing on the original real-time interaction data, and obtaining pre-processed original real-time interaction data, the following may be implemented: categorizing the original real-time interaction data to obtain categorized real-time interaction data, where the categorized real-time interaction data includes, but is not limited to, playback history data, skip behavior data, dwell time data and operation behavior data. The playback history data is, for example, an identifier ID of a song played by the user, playback time, playback order, etc. The skip behavior data is, for example, an ID of a song skipped by the user, a skip time point, playback duration before skipping, etc. The dwell time data is, for example, the quantity of complete plays of each song and the average listening duration of each song. The operation behavior data is such operation data as likes, favorites, shares by the user. The following may be further implemented: performing cleaning processing on outliers and duplicate data in the categorized real-time interaction data based on a preset validation rule to obtain cleaned real-time interaction data, where the validation rule includes, but is not limited to, format check, range check, data integrity and standardization. Outliers may be abnormal data caused by network issues or unintended operations, for example, recorded data whose playback duration is less than preset duration (e.g., the preset duration is 5 seconds). The following may be further implemented: normalizing data of different dimensions in the cleaned real-time interaction data to the same scale to obtain preprocessed original real-time interaction data, so as to implement standardization processing for subsequent analysis. For example, the playback duration in the cleaned real-time interaction data is converted into a complete playback rate as follows: Complete playback rate=actual playback duration/total duration of a song.

In one implementation, the quantity of user in the target user is at least one.

In one implementation, a size dimension of the interaction matrix is M*N, where M is the quantity of user and N is the quantity of song. The interaction matrix is generated based on a preset calculation formula and the pre-processed original real-time interaction data, and the calculation formula is specifically as follows:

$$score ( u , i ) = α * play\_count ( u , i ) + β * complete\_rate ( u , i ) + γ * like\_count ( u , i )$$

where score(u, i) is an implicit score of a song from the target user, u is the target user, i is the song, α, β and γ are each a weight coefficient, which may be optimized through experiments, play_count(u, i) is the quantity of times of the song that has been played by the target user, complete_rate(u, i) is a completion rate for the song from the target user, and like_count(u, i) is a like rate for the song from the target user.

In one implementation, the process of performing data cleaning on the original historical behavior data is similar to the process of performing data cleaning on the outliers and duplicate data in the categorized real-time interaction data based on the preset validation rule to obtain the cleaned real-time interaction data as described above, and the process of performing standardization processing on the cleaned original historical behavior data is similar to the process of normalizing the data of different dimensions in the cleaned real-time interaction data to the same scale to obtain the preprocessed original real-time interaction data as described above, and the description thereof is omitted herein.

Through performing data cleaning and standardization processing on the original real-time interaction data and original historical behavior data, and generating an interaction matrix based on the pre-processed original real-time interaction data, it is able to improve the data quality of the real-time user interaction data and historical user usage data, reduce the computational complexity, and improve the efficiency of subsequent data analysis. Hence, these data can be applied to complex machine learning models, the generalization capability of the subsequently generated target model is enhanced, which is beneficial for improving the accuracy of subsequent song recommendations.

Step 302, generating, based on the real-time user interaction data and the historical user usage data, a target model, where the target model is a model representing user preferences.

In one implementation, when generating the target model based on the real-time user interaction data and the historical user usage data, the following may be implemented: generating a first model based on the real-time user interaction data, where the first model is used to indicate the distribution of song topics that the user is interested in; generating a second model based on the historical user usage data, where the second model is used to predict a song preferred by the user; obtaining associated data of the songs, where the associated data is used to indicate a factor that influences a degree of the user's interest in a song; generating a third model based on the associated data, where the third model is a model of context correlation that influences the degree of interest in the song; and determining the target model based on the first model, the second model and the third model.

In one implementation, when generating a first model based on the real-time user interaction data, the following may be implemented: performing sliding processing (sub-sequence identifier) on the real-time user interaction data through a preset sliding window algorithm to obtain window-processed data; clustering songs in a window in the window-processed data to obtain the distribution of song topics that the user is interested in; and generating a topic model based on the distribution of song topics that the user is interested in to obtain a first model. The first model may be a Latent Dirichlet Allocation (LDA) topic model. The first model may be specifically: P(z|d)~Dir(α), P(w|z)~Dir(β), z is the topic, d is the user's playback sequence, w is the song, a and β are each a hyperparameter.

In one implementation, when generating a second model based on the historical user usage data, the following may be implemented: generating a user profile based on the historical user usage data, where each user corresponds to one user profile, and the user profile includes, but is not limited to, user basic information, behavior characteristics, interest preferences, and time-series behavior patterns. The following may be further implemented: performing feature extraction on interest preference information in the user profile to obtain user preference features. The user preference features include, but are not limited to, music style features, era features and language features. The following may be further implemented: generating a Factorization Machines model based on the user preference features to obtain the second model.

In one implementation, the associated data may be such context factors as time, place, and mood that affect the user's degree of interest in a song. The third model is generated based on the associated data, and the third model may be a context-aware matrix factorization model. The third model is specifically as follows: R(u, i, c)≈P(u)^{T}*Q(i)*C(c), where R(u,i,c) is a rating matrix, P is a latent vector of user, Q is a latent vector of song, C is a latent vector of context, u is an identifier of the user, i is an identifier of the song, c is an index or attribute of the context, and T is a transpose operator. When generating the context-aware matrix factorization model based on the associated data of song, it is able to improve the accuracy and diversity of recommendations of the target model.

In one implementation, the first model, the second model and the third model may be determined as the target model, or, the first model, the second model and the third model are connected according to a preset hierarchical structure to obtain the target model.

In one implementation, a speed layer in a pre-generated real-time recommendation system architecture (for example, Lambda architecture) processes the real-time user interaction data of songs by using stream processing (for example, Apache Flink) in real time. A batch processing layer in the real-time recommendation system architecture performs offline analysis on the historical user usage data and updates the user profile and a model parameter. A serving layer in the real-time recommendation system architecture merges a batch processing result of the batch processing layer and a stream processing result of the stream processing layer, so as to provide low-latency recommendation services. Through the real-time recommendation system architecture, low-latency recommendation services are achieved.

When generating the first model based on the real-time user interaction data, generating the second model based on the historical user usage data, generating the third model based on the associated data, and determining the target model based on the first model, the second model and the third model, it is able to capture the user's short-term interest changes and long-term preferences, achieve accurate modeling of user interests, improve the accuracy and diversity of recommendations by the target model, make recommended songs more suitable for the user's personalization, and enhance user satisfaction.

Step 303, performing multimodal music feature extraction on the real-time user interaction data, the historical user usage data and a preset song database, and obtaining the multimodal music features.

In one implementation, when performing multimodal music feature extraction on the real-time user interaction data, the historical user usage data and the preset song database and obtaining the multimodal music features, the following may be implemented: extracting an audio feature of a song from the real-time user interaction data, the historical user usage data and songs in the preset song database through a preset feature extraction model, and obtaining a target audio feature, where the feature extraction model comprises at least one type of extraction algorithm; extracting a lyric semantic feature of the song from the real-time user interaction data, the historical user usage data and the songs in the preset song database through a preset language model, and obtaining a target lyric semantic feature; extracting metadata of the song from the real-time user interaction data, the historical user usage data and the songs in the preset song database through a preset data integration model, performing metadata integration, and obtaining target metadata; and determining the target audio feature, the target lyric semantic feature and the target metadata as the multimodal music features.

In one implementation, a low-level acoustic feature of song is extracted from the real-time user interaction data and historical user usage data through a first feature extraction model (for example, a Perceptual Linear Predictive (PLP) model, a Mel-frequency envelope (MFE) model) in the preset feature extraction model, to obtain a first low-level acoustic feature. The low-level acoustic feature includes, but is not limited to, Mel-frequency cepstral coefficient (MFCC), chroma feature and rhythm feature. A high-level music attribute of song is calculated from the real-time user interaction data and historical user usage data through an attribute calculation model (for example, a MuseBERT model) in the feature extraction model, to obtain a first high-level music attribute. The high-level music attribute includes, but is not limited to, emotional attribute, energy attribute and dance attribute. Feature extraction is performed on songs in the preset song database through a second feature extraction model (for example, a librosa library) in the feature extraction model, to obtain a database music feature. The database music feature includes, but is not limited to, the first low-level acoustic feature and the first high-level music attribute. The low-level acoustic feature, the high-level music attribute and the database music feature are determined as the target audio feature. When extracting audio features of multiple data through the feature extraction model, it realizes multi-dimensional feature extraction and improves the validity and reliability of the target audio features.

In one implementation, the audio features of songs may be extracted from the real-time user interaction data, the historical user usage data and the preset song database through the preset feature extraction model (the feature extraction model includes only one type of algorithm, for example, the librosa library) to obtain the target audio feature.

In one implementation, when extracting the lyric semantic feature of the song from the real-time user interaction data, the historical user usage data and the preset song database through a preset language model and obtaining the target lyric semantic feature, the following may be implemented: analyzing and extracting a lyric content from the real-time user interaction data, the historical user usage data and the preset song database through a first language model in the preset language model, to obtain the lyric content, where the first language model may be a BERT pre-trained language model; analyzing and extracting a specified feature of song from the real-time user interaction data, the historical user usage data and the preset song database through a second language model in the language model, to obtain the specified feature, where the specified feature includes, but is not limited to, lyric theme, emotional tendency and complexity; and determining the lyric content and the specified feature as the target lyric semantic feature.

In one implementation, when extracting metadata of the song from the real-time user interaction data, the historical user usage data and the preset song database through a preset data integration model, performing metadata integration and obtaining target metadata, the following may be implemented: extracting structured information of the song from the real-time user interaction data, the historical user usage data and the preset song database through a first integration model in the preset data integration model, to obtain the metadata, where the first integration model is a custom entity extraction model or a pre-generated entity extraction model, and the metadata includes entities and an entity relationship; learning a low-dimensional representation of the entities and the entity relationship through a second integration model in the data integration model based on the metadata, and generating a knowledge graph based on the low-dimensional representation of entities and entity relationship to perform metadata integration and obtain the target metadata. The low-dimensional representation may be: h+r≈t, h is a vector representation of a head entity, r is a vector representation of the entity relationship, t is a vector representation of a tail entity.

By extracting multimodal music features including the target audio feature, the target lyric semantic feature and the target metadata from multiple data, it is beneficial for capturing user preferences, realizing the synergistic effect of multimodal features, and improving the accuracy and reliability of the multimodal music features.

Step 304, fusing the multimodal music features based on a preset attention mechanism, and obtaining the target music feature.

In one implementation, weighted processing may be performed on the multimodal music features based on the preset attention mechanism to obtain the target music feature. The attention mechanism may be specifically: fused_feature=Σᵢαᵢ;*fᵢ, aᵢ is an attention weight of an i-th feature modality, and fᵢ is a corresponding feature vector.

Step 305, obtaining the currently playing song, performing a search on the preset song database based on the currently playing song and preset search algorithms, and obtaining the set of candidate songs.

By fusing multi-modal music features based on the preset attention mechanism, multiple types of information are comprehensively considered, the comprehensiveness of feature representation is improved, the characteristics of musical works (songs) are comprehensively described, and the accuracy and efficiency of song recommendation can be improved. By performing search on the preset song database based on the currently played song and the preset search algorithm, the accuracy of the set of candidate songs is improved, thereby providing personalized recommendation.

In one implementation, when performing the search on the preset song database based on the currently playing song and the preset search algorithms and obtaining the set of candidate songs, the following may be implemented: performing multimodal music feature extraction on the currently playing song, and obtaining a current music feature; performing a search on the preset song database based on the current music feature using a first search algorithm and a second search algorithm in the preset search algorithms, and obtaining a first set of song and a second set of song; performing a search on the preset song database based on the current music feature using a third search algorithm in the preset search algorithms, and obtaining a third set of song; where a search level of the third search algorithm is higher than that of each of the first search algorithm and the second search algorithm; fusing the first set of song and the second set of song, and obtaining a fused set of song; and filtering the fused set of song through the third set of song, and obtaining the set of candidate songs.

In one implementation, the first search algorithm may be a locality-sensitive hashing algorithm. The locality-sensitive hashing algorithm is specifically: h(x)=floor((a·x+b)/r), a is a random vector, b is a random bias, r is a bucket width. The second search algorithm may be a linear search algorithm, and the third search algorithm may be a depth-first search algorithm or a breadth-first search algorithm. The search level of the third search algorithm being higher than that of each of the first search algorithm and the second search algorithm may be understood as: the search efficiency and accuracy of the third search algorithm are both higher than those of the first search algorithm and the second search algorithm.

In one implementation, the first set of song and the second set of song are merged, and the merged set of song is deduplicated to fuse the first set of song and the second set of song, thereby to obtain a fused set of song. A similarity between a song in the third set of song and a song in the fused set of song is calculated, and a song in the fused set of song whose similarity is less than a preset similarity is deleted, so as to obtain the set of candidate songs.

When performing search through multiple search algorithms and filtering among the search results, it is able to improve the recall rate and precision rate, enhance the diversity and comprehensiveness of the search results, and improve the accuracy and reliability of the set of candidate songs.

Step 306, generating, based on the target model and the target music feature, a dynamic queue of the set of candidate songs, and obtaining a set of to-be-played songs.

In one implementation, when generating the dynamic queue of the set of candidate songs based on the target model and the target music feature and obtaining the set of to-be-played song, the following may be implemented: calculating, based on the target model and the target music feature, an overall score corresponding to each candidate song in the set of candidate songs; sorting candidate songs in the set of candidate songs according to the overall score, and obtaining a candidate song sequence; filtering, based on a preset selection algorithm, the candidate song sequence, and obtaining a filtered candidate song sequence; and generating, based on a preset recommendation algorithm, a dynamic queue of the filtered candidate song sequence, and obtaining the set of to-be-played song.

In one implementation, the overall score corresponding to each candidate song in the set of candidate songs may be calculated through the target model and the target music feature based on a scoring function.

The scoring function is specifically as follows: score(u,i)=w₁*relevance (u,i)+W₂*diversity(i, history)+w₃*Novelty (u,i)+w₄*Context_Score(u, i, c), where u is an Identifier of the User, iⁱ is an Identifier of the Song, c is an index or attribute of the context, w₁, w₂, w₃ and w₄ are each a weight coefficient, relevance is a relevance to user interest, diversity refers to the diversity of the historical playback list, novelty refers to the novelty to the user, context_score refers to the context correlation. The selection algorithm may be a lightweight online learning algorithm (e.g., a bandit algorithm), for example, the Upper Confidence Bound (UCB) algorithm, Thompson Sampling algorithm, UCB(i)=μi+sqrt(2*In(n)/ni), μi is a mean reward of arm i, n is the total quantity of attempts, ni is the number of times arm i has been selected.

In one implementation, when generating the dynamic queue of the set of candidate songs based on a preset recommendation algorithm and obtaining the set of to-be-played song, the following may be implemented: writing the filtered candidate song sequence into a dynamic queue structure with a preset length to obtain an initial queue; generating a queue of the filtered candidate song sequence through a preset recommendation algorithm to obtain a recommendation queue, where the preset length may be 50 songs; defining a smoothing factor, configuring the initial queue through a preset sliding window algorithm and the smoothing factor, to obtain a new queue structure, and obtain the set of to-be-played song, so as to achieve local dynamic adjustment while maintaining overall coherence. The new queue structure is specifically as follows: Q_new=λ*Q_old+(1-λ)*Q_recommended, where Q_old is the initial queue, A is the smoothing factor, 0<λ<1, Q_recommended is the recommendation queue.

By obtaining the filtered candidate song sequence through the overall score calculated based on the target model and the target music feature, generating the dynamic queue of the filtered candidate song sequence, and optimizing the queue structure, intelligent dynamic adjustment of the music playback queue is achieved, the recommendation effect is continuously optimized based on user real-time feedback, which can accurately match user needs, provide a highly personalized and dynamically responsive music playback experience, and improve the user's personalized music listening experience.

In one implementation, subsequent to generating the dynamic queue of the set of candidate songs based on the target model and the target music feature and obtaining the set of to-be-played song, the following may be implemented: obtaining feedback information about the set of to-be-played song; and updating, based on the feedback information and a preset learning algorithm, a recommendation strategy and a model parameter of the target model in real time.

In one implementation, when updating the recommendation strategy and the model parameter of the target model in real time based on the feedback information and the preset learning algorithm, the following may be implemented: learning the feedback information through a preset online learning algorithm (for example, the Online Gradient Descent algorithm), and updating the model parameter of the target model in real time according to a learned content and a preset parameter update rule. The parameter update rule may be specifically as follows: θt+1=θt−η*∇L(θt, xt, yt), θt is the model parameter of the target model, η is a learning rate, L is a loss function, xt is an input feature, yt is a target value. The following may be further implemented: migrating a preference model of a user similar to a new user to a song recommendation system for the new user through a preset transfer learning algorithm and a preset content-based recommendation strategy. The new user may be understood as: a user after the user who uses the current real-time user interaction data and historical user usage data, or a user whose registration time is after the current time, or a first-time active user, etc. The following may be further implemented: determining the user similar to the new user through such a parallel computing method as a Map-Reduce mode. The user similar to the new user is determined as follows: Map: (user_id, item_preferences)-> [(item_id, (user_id, preference))], Reduce: (item_id, [(user_id1, pref1), (user_id2, pref2), . . . ])-> [(user_id1, user_id2, similarity)]. The transfer learning algorithm is specifically as follows: Lₙ_{_{ew}}=Lₒₗ_{_{d}}+/*∥Wₙ_{_{ew}}-Wₒ_{_{ld}}∥², where Lₙ_{_{ew}} is a loss function of a new task, Lₒ_{_{ld}} is a loss function of an old task, λ is a regularization coefficient, Wₙ_{_{ew}} is a new model parameter, Wₒ_{_{ld}} is an old model parameter. Specifically, the gradient of the loss function with respect to the model parameter of the target model may be calculated through the preset online learning algorithm and feedback information, and the parameter of the target model may be updated according to the gradient and the preset parameter update rule.

By updating the recommendation strategy and model parameter of the target model in real time based on the feedback information and the preset learning algorithm, the recommendation effect can be continuously optimized based on user real-time feedback, which helps improve the accuracy of song recommendation, achieve personalized recommendation and model optimization, and enhance the user's personalized music listening experience.

In one implementation, when obtaining feedback information about the set of to-be-played song, the following may be implemented: obtaining user evaluation information about the set of to-be-played song; monitoring user playback behavior data of the set of to-be-played song in real time; predicting a playback duration of the set of to-be-played song through a preset analysis model based on the user playback behavior data; and determining the user evaluation information and the playback duration as the feedback information about the set of to-be-played song.

In one implementation, the user evaluation information includes, but is not limited to, a satisfaction score, a tag selection, and user evaluation information on the recommendation result. The user playback behavior data includes, but is not limited to, skip rate and complete playback rate. The analysis model may be a Survival Analysis Model, specifically as follows: S(t)=exp (−λt), where S(t) is a survival function, λ is a hazard rate, t is the playback duration of the set of to-be-played song.

By obtaining the user evaluation information and predicting the playback duration of the set of to-be-played song through the preset analysis model based on the user playback behavior data, to obtain the feedback information about the set of to-be-played song, resource usage efficiency can be improved while optimizing user experience, which helps enhance personalized experience and improve user retention and user engagement.

In one implementation, a graphical user interface is provided through a terminal device. The graphical user interface includes a plurality of sets of controls, and the plurality of sets of controls is configured to obtain the user evaluation information about the set of to-be-played song. The user evaluation information includes a plurality of types of feedback information, and one set of controls corresponds to one type of feedback information.

In one implementation, multiple sets of controls are displayed in the graphical user interface according to a preset order and layout content. The multiple sets of controls in the user graphical interface may be displayed in the form of a floating window, or may be hidden in a specified area of the user experience interface. When responding to a trigger operation for control display, the multiple sets of controls are displayed in the graphical user interface. One set of controls is used to obtain one type of feedback information, and types of feedback information obtained by the sets of controls are different from each other.

By obtaining the user evaluation information about the set of to-be-played songs through multiple sets of controls in the graphical user interface, the intuitiveness and interactivity of the user experience are enhanced, which helps to understand user preferences more finely and provides a rich data basis for subsequent personalized recommendations.

In one implementation, the computer-implemented method of song recommendation further includes: caching the real-time user interaction data and historical user usage data of songs through a preset multi-level caching mechanism, and managing data in the cache through a preset management algorithm.

In one implementation, the multi-level caching mechanism may be a local cache or a distributed cache (e.g., Redis). The preset management algorithm may be a Least Recently Used (LRU) algorithm.

In one implementation, the computer-implemented method of song recommendation may further include: monitoring a storage status of data in the cache in real time through a preset management algorithm; deleting the data that has been stored for the longest time and is unused in the cache when the storage status indicates that the cache is full; taking no action and continuing real-time monitoring when the storage status indicates that the cache is not full.

By caching the real-time user interaction data and historical user usage data of songs through a multi-level caching mechanism and managing the cached data via a preset management algorithm, it is able to accelerate access to the real-time user interaction data and historical user usage data, optimize resource utilization, facilitate subsequent data processing of the real-time user interaction data and historical user usage data, ensure data security and stability of the real-time user interaction data and historical user usage data, and enhance fault tolerance.

In one implementation, the computer-implemented method of song recommendation further includes: performing management and control on the real-time user interaction data, the historical user usage data, the target model, the target music feature and/or the set of to-be-played songs through a preset master-slave replication mechanism and a failover mechanism.

In one implementation, load balancing processing is performed on the real-time user interaction data, the historical user usage data, the target model, the target music feature, and/or the set of to-be-played songs through a preset consistent hashing algorithm to obtain processed data. The consistent hashing algorithm is specifically as follows: hash (key)=((α*key+b)/p)/m, where a and b are each a random number, p is a large prime number, m is the number of slots. The processed data is managed and controlled through the preset master-slave replication mechanism and failover mechanism. The master-slave replication mechanism includes, but is not limited to, an asynchronous replication mode, a semi-synchronous replication mode, and a fully synchronous replication mode, and a corresponding master-slave replication mode may be selected according to the real-time performance of data. The implementation manners of the failover mechanism include, but are not limited to, redundant backup, heartbeat detection and containerized deployment.

By implementing data management and control through the master-slave replication mechanism and the failover mechanism, data availability, fault tolerance, and read performance are improved, data availability is enhanced, data consistency is ensured, and fault tolerance is strengthened.

In one implementation, large-scale data may be processed through a distributed computing framework such as Apache Spark, where the large-scale data may include at least one of the real-time user interaction data, the historical user usage data, the target model, the target music feature, and the set of to-be-played songs.

In this embodiment, the dynamic queue of the set of candidate songs similar to the currently playing song is generated according to a target model, which is generated based on the real-time user interaction data and the historical user usage data, and the target music feature, so as to enhance the diversification of data analysis factors for song recommendation, realize intelligent dynamic adjustment of the music playback queue, provide a user with a highly personalized and dynamically responsive music playback experience, and improve the accuracy of played songs. Moreover, it comprehensively considers user behaviors, music features and context information, and can dynamically adjust the dynamic queue of the set of to-be-played songs in real time, thereby improving the user's personalized music listening experience, and increasing the user's usage duration and user engagement on the music playback platform. In addition, it is capable of intelligently predicting the user's next optimal song, and significantly improves user satisfaction and platform stickiness.

The embodiments of the present disclosure further provide a computer-readable storage medium having stored thereon computer-executable instructions, where the computer-executable instructions, when called and executed by a processor, cause the processor to implement the following steps: obtaining real-time user interaction data and historical user usage data of songs; generating, based on the real-time user interaction data and the historical user usage data, a target model, where the target model is a model representing user preferences; obtaining a target music feature and a set of candidate songs similar to a currently playing song; where the target music feature is a feature obtained by fusing multimodal music features; and generating, based on the target model and the target music feature, a dynamic queue of the set of candidate songs, and obtaining a set of to-be-played song.

In one implementation, the obtaining real-time user interaction data and historical user usage data of songs includes: obtaining original real-time interaction data and original historical behavior data of a target user for songs; performing data cleaning and standardization processing on the original real-time interaction data, and obtaining pre-processed original real-time interaction data; generating, based on the pre-processed original real-time interaction data, an interaction matrix; where the interaction matrix is used to indicate implicit scores of the songs from the target user; and performing data cleaning and standardization processing on the original historical behavior data, and obtaining the historical user usage data.

In one implementation, generating the target model based on the real-time user interaction data and the historical user usage data includes: generating a first model based on the real-time user interaction data, where the first model is used to indicate the distribution of song topics that the user is interested in; generating a second model based on the historical user usage data, where the second model is used to predict a song preferred by the user; obtaining associated data of the songs, where the associated data is used to indicate a factor that influences a degree of the user's interest in a song; generating a third model based on the associated data, where the third model is a model of context correlation that influences the degree of interest in the song; and determining the target model based on the first model, the second model and the third model.

In one implementation, obtaining the target music feature and the set of candidate songs similar to the currently playing song includes: performing multimodal music feature extraction on the real-time user interaction data, the historical user usage data, and a preset song database, and obtaining the multimodal music features; fusing the multimodal music features based on a preset attention mechanism, and obtaining the target music feature; and obtaining the currently playing song, performing a search on the preset song database based on the currently playing song and preset search algorithms, and obtaining the set of candidate songs.

In one implementation, performing multimodal music feature extraction on the real-time user interaction data, the historical user usage data and the preset song database and obtaining the multimodal music features includes: extracting an audio feature of a song from the real-time user interaction data, the historical user usage data and the preset song database through a preset feature extraction model, and obtaining a target audio feature, where the feature extraction model includes at least one type of extraction algorithm; extracting a lyric semantic feature of the song from the real-time user interaction data, the historical user usage data and the preset song database through a preset language model, and obtaining a target lyric semantic feature; extracting metadata of the song from the real-time user interaction data, the historical user usage data and the preset song database through a preset data integration model, performing metadata integration, and obtaining target metadata; and determining the target audio feature, the target lyric semantic feature and the target metadata as the multimodal music features.

In one implementation, performing the search on the preset song database based on the currently playing song and the preset search algorithms and obtaining the set of candidate songs includes: performing multimodal music feature extraction on the currently playing song, and obtaining a current music feature; performing a search on the preset song database based on the current music feature using a first search algorithm and a second search algorithm in the preset search algorithms, and obtaining a first set of song and a second set of song; performing a search on the preset song database based on the current music feature using a third search algorithm in the preset search algorithms, and obtaining a third set of song; where a search level of the third search algorithm is higher than that of each of the first search algorithm and the second search algorithm; fusing the first set of song and the second set of song, and obtaining a fused set of song; and filtering the fused set of song through the third set of song, and obtaining the set of candidate songs.

In one implementation, generating the dynamic queue of the set of candidate songs based on the target model and the target music feature and obtaining the set of to-be-played song includes: calculating, based on the target model and the target music feature, an overall score corresponding to each candidate song in the set of candidate songs; sorting candidate songs in the set of candidate songs according to the overall score, and obtaining a candidate song sequence; filtering, based on a preset selection algorithm, the candidate song sequence, and obtaining a filtered candidate song sequence; and generating, based on a preset recommendation algorithm, the dynamic queue of the filtered candidate song sequence, and obtaining the set of to-be-played song.

In one implementation, the following is further implemented: subsequent to generating the dynamic queue of the set of candidate songs based on the target model and the target music feature and obtaining the set of to-be-played song, obtaining feedback information about the set of to-be-played song; and updating, based on the feedback information and a preset learning algorithm, a recommendation strategy and a model parameter of the target model in real time.

In one implementation, obtaining feedback information about the set of to-be-played song includes: obtaining user evaluation information about the set of to-be-played song; monitoring user playback behavior data of the set of to-be-played song in real time; predicting a playback duration of the set of to-be-played song through a preset analysis model based on the user playback behavior data; and determining the user evaluation information and the playback duration as the feedback information about the set of to-be-played song.

In one implementation, the following is further implemented: providing, through a terminal device, a graphical user interface; where the graphical user interface includes a plurality of sets of controls, the plurality of sets of controls is configured to obtain the user evaluation information about the set of to-be-played song; and the user evaluation information includes a plurality of types of feedback information, and one set of controls corresponds to one type of feedback information.

In one implementation, the following is further implemented: caching real-time user interaction data and historical user usage data of songs through a preset multi-level caching mechanism, and managing data in the cache through a preset management algorithm.

In one implementation, the following is further implemented: performing management and control on the real-time user interaction data, the historical user usage data, the target model, the target music feature and/or the set of to-be-played songs through a preset master-slave replication mechanism and a failover mechanism.

The embodiments of the present disclosure provide a computer program product of the computer-implemented method for song recommendation, the electronic device and the storage medium, including a computer-readable storage medium having stored thereon program code. The program code includes instructions executable to perform the method in the above-mentioned embodiments. For details of the implementation, reference may be made to the description in the method embodiments, which will not be elaborated again herein.

Those skilled in the art may clearly understand that, for the sake of convenience and brevity of description, the specific working process of the system, apparatus and units mentioned above can refer to the corresponding processes in the method embodiments, which are not elaborated again herein.

In the embodiments of the present disclosure, unless explicitly specified or defined otherwise, terms such as “install”, “connect”, and “connection” should be construed in a broad sense. For example, it may be a fixed connection, or a detachable connection, or integral; it may be a mechanic connection or an electrical connection; it may be a direct connection, or an indirect connection via an intermediate medium, or an interior connection of two elements. A person of ordinary skill in the art may derive the specific meaning of the term in the present disclosure according to the specific situation.

If the function is implemented in the form of software functional units and sold or used as an independent product, it may be stored in a computer readable storage medium. Based on this comprehension, essence of the technical solutions of the present disclosure, or the part contributing to the related art, or part of the technical solutions, may be embodied in the form of a software product. The computer software product is stored in a storage medium, and includes a number of instructions to enable a computer device (which may be a personal computer, a server, or a network device, etc.) to perform all or part of the steps of method described in the various embodiments of the present disclosure. The storage medium includes a USB flash disk, a mobile hard disk, a read-only memory (Read-Only Memory, ROM), a random access memory (Random Access Memory, RAM), a magnetic disk, an optical disk, or other medium which can store program code.

In the embodiments of the present disclosure, such words as “in the middle of”, “on/above”, “under/below”, “left”, “right”, “vertical”, “horizontal”, “inside” and “outside” may be used to indicate directions or positions as viewed in the drawings, and they are merely used to facilitate the description in the present disclosure, rather than to indicate or imply that a device or member must be arranged or operated at a specific position. In addition, such words as “first”, “second” and “third” may be merely used to differentiate different components rather than to indicate or imply any importance.

It should be noted that the above embodiments are merely specific implementations of the present disclosure and are used to illustrate the technical solutions of the present disclosure, but shall not be construed as limiting the present disclosure. The scope of the present disclosure is not limited to these embodiments. As can be appreciated by a person skilled in the art, although the present disclosure has been described in detail with reference to the foregoing embodiments, any modifications or variations of the technical solutions in the aforementioned embodiments, or equivalent replacements of part of the technical features within the scope of the disclosed technology, may still be made by those skilled in the art. These modifications, variations or replacements do not make the essence of the corresponding technical solutions depart from the spirit and scope of the technical solutions of the embodiments of the present application. The scope of the present disclosure shall be subject to the scope defined by the appended claims.

What is claimed is:

1. A computer-implemented method of song recommendation, comprising:
obtaining real-time user interaction data and historical user usage data of songs;
generating, based on the real-time user interaction data and the historical user usage data, a target model, wherein the target model is a model representing user preferences;
obtaining a target music feature and a set of candidate songs similar to a currently playing song; wherein the target music feature is a feature obtained by fusing multimodal music features; and
generating, based on the target model and the target music feature, a dynamic queue of the set of candidate songs, and obtaining a set of to-be-played songs.

2. The computer-implemented method of song recommendation according to claim 1, wherein the obtaining real-time user interaction data and historical user usage data of songs comprises:
obtaining original real-time interaction data and original historical behavior data of a target user for songs;
performing data cleaning and standardization processing on the original real-time interaction data, and obtaining pre-processed original real-time interaction data;
generating, based on the pre-processed original real-time interaction data, an interaction matrix; wherein the interaction matrix is used to indicate implicit scores of the songs from the target user; and
performing data cleaning and standardization processing on the original historical behavior data, and obtaining the historical user usage data.

3. The computer-implemented method of song recommendation according to claim 1, wherein generating the target model based on the real-time user interaction data and the historical user usage data comprises:
generating a first model based on the real-time user interaction data, wherein the first model is used to indicate the distribution of song topics that the user is interested in;
generating a second model based on the historical user usage data, wherein the second model is used to predict a song preferred by the user;
obtaining associated data of the songs, wherein the associated data is used to indicate a factor that influences a degree of the user's interest in a song;
generating a third model based on the associated data, wherein the third model is a model of context correlation that influences the degree of interest in the song; and
determining the target model based on the first model, the second model and the third model.

4. The computer-implemented method of song recommendation according to claim 1, wherein obtaining the target music feature and the set of candidate songs similar to the currently playing song comprises:
performing multimodal music feature extraction on the real-time user interaction data, the historical user usage data and a preset song database, and obtaining the multimodal music features;
fusing the multimodal music features based on a preset attention mechanism, and obtaining the target music feature; and
obtaining the currently playing song, performing a search on the preset song database based on the currently playing song and preset search algorithms, and obtaining the set of candidate songs.

5. The computer-implemented method of song recommendation according to claim 4, wherein performing multimodal music feature extraction on the real-time user interaction data, the historical user usage data and the preset song database and obtaining the multimodal music features comprises:
extracting an audio feature of a song from the real-time user interaction data, the historical user usage data and the preset song database through a preset feature extraction model, and obtaining a target audio feature, wherein the feature extraction model comprises at least one type of extraction algorithm;
extracting a lyric semantic feature of the song from the real-time user interaction data, the historical user usage data and the preset song database through a preset language model, and obtaining a target lyric semantic feature;
extracting metadata of the song from the real-time user interaction data, the historical user usage data and the preset song database through a preset data integration model, performing metadata integration, and obtaining target metadata; and
determining the target audio feature, the target lyric semantic feature and the target metadata as the multimodal music features.

6. The computer-implemented method of song recommendation according to claim 4, wherein performing the search on the preset song database based on the currently playing song and the preset search algorithms and obtaining the set of candidate songs comprises:
performing multimodal music feature extraction on the currently playing song, and obtaining a current music feature;
performing a search on the preset song database based on the current music feature using a first search algorithm and a second search algorithm in the preset search algorithms, and obtaining a first set of songs and a second set of songs;
performing a search on the preset song database based on the current music feature using a third search algorithm in the preset search algorithms, and obtaining a third set of songs; wherein a search level of the third search algorithm is higher than that of each of the first search algorithm and the second search algorithm;
fusing the first set of songs and the second set of songs, and obtaining a fused set of songs; and
filtering the fused set of songs through the third set of songs, and obtaining the set of candidate songs.

7. The computer-implemented method of song recommendation according to claim 1, wherein generating the dynamic queue of the set of candidate songs based on the target model and the target music feature and obtaining the set of to-be-played song comprises:
calculating, based on the target model and the target music feature, an overall score corresponding to each candidate song in the set of candidate songs;
sorting candidate songs in the set of candidate songs according to the overall score, and obtaining a candidate song sequence;
filtering, based on a preset selection algorithm, the candidate song sequence, and obtaining a filtered candidate song sequence; and
generating, based on a preset recommendation algorithm, a dynamic queue of the filtered candidate song sequence, and obtaining the set of to-be-played songs.

8. The computer-implemented method of song recommendation according to claim 1, further comprising:
subsequent to generating the dynamic queue of the set of candidate songs based on the target model and the target music feature and obtaining the set of to-be-played songs, obtaining feedback information about the set of to-be-played songs; and
updating, based on the feedback information and a preset learning algorithm, a recommendation strategy and a model parameter of the target model in real time.

9. The computer-implemented method of song recommendation according to claim 8, wherein obtaining feedback information about the set of to-be-played songs comprises:
obtaining user evaluation information about the set of to-be-played songs;
monitoring user playback behavior data of the set of to-be-played songs in real time;
predicting a playback duration of the set of to-be-played songs through a preset analysis model based on the user playback behavior data; and
determining the user evaluation information and the playback duration as the feedback information about the set of to-be-played songs.

10. The computer-implemented method of song recommendation according to claim 9, further comprising:
providing, through a terminal device, a graphical user interface; wherein
the graphical user interface comprises a plurality of sets of controls, the plurality of sets of controls is configured to obtain the user evaluation information about the set of to-be-played songs; and
the user evaluation information comprises a plurality of types of feedback information, and one set of controls corresponds to one type of feedback information.

11. The computer-implemented method of song recommendation according to claim 1, further comprising:
caching real-time user interaction data and historical user usage data of songs through a preset multi-level caching mechanism, and managing data in the cache through a preset management algorithm.

12. The computer-implemented method of song recommendation according to claim 1, further comprising:
performing management and control on the real-time user interaction data, the historical user usage data, the target model, the target music feature and/or the set of to-be-played songs through a preset master-slave replication mechanism and a failover mechanism.

13. An electronic device, comprising a processor and a memory, wherein the memory stores machine-executable instructions executable by the processor, and the machine-executable instructions, when executed by the processor, cause the processor to implement following steps:
obtaining real-time user interaction data and historical user usage data of songs;
generating, based on the real-time user interaction data and the historical user usage data, a target model, wherein the target model is a model representing user preferences;
obtaining a target music feature and a set of candidate songs similar to a currently playing song; wherein the target music feature is a feature obtained by fusing multimodal music features; and
generating, based on the target model and the target music feature, a dynamic queue of the set of candidate songs, and obtaining a set of to-be-played songs.

14. The electronic device according to claim 13, wherein the obtaining real-time user interaction data and historical user usage data of songs comprises:
obtaining original real-time interaction data and original historical behavior data of a target user for songs;
performing data cleaning and standardization processing on the original real-time interaction data, and obtaining pre-processed original real-time interaction data;
generating, based on the pre-processed original real-time interaction data, an interaction matrix; wherein the interaction matrix is used to indicate implicit scores of the songs from the target user; and
performing data cleaning and standardization processing on the original historical behavior data, and obtaining the historical user usage data.

15. The electronic device according to claim 13, wherein generating the target model based on the real-time user interaction data and the historical user usage data comprises:
generating a first model based on the real-time user interaction data, wherein the first model is used to indicate the distribution of song topics that the user is interested in;
generating a second model based on the historical user usage data, wherein the second model is used to predict a song preferred by the user;
obtaining associated data of the songs, wherein the associated data is used to indicate a factor that influences a degree of the user's interest in a song;
generating a third model based on the associated data, wherein the third model is a model of context correlation that influences the degree of interest in the song; and
determining the target model based on the first model, the second model and the third model.

16. The electronic device according to claim 13, wherein obtaining the target music feature and the set of candidate songs similar to the currently playing song comprises:
performing multimodal music feature extraction on the real-time user interaction data, the historical user usage data, and a preset song database, and obtaining the multimodal music features;
fusing the multimodal music features based on a preset attention mechanism, and obtaining the target music feature; and
obtaining the currently playing song, performing a search on the preset song database based on the currently playing song and preset search algorithms, and obtaining the set of candidate songs.

17. The electronic device according to claim 16, wherein performing multimodal music feature extraction on the real-time user interaction data, the historical user usage data and the preset song database and obtaining the multimodal music features comprises:
extracting an audio feature of a song from the real-time user interaction data, the historical user usage data and the preset song database through a preset feature extraction model, and obtaining a target audio feature, wherein the feature extraction model comprises at least one type of extraction algorithm;
extracting a lyric semantic feature of the song from the real-time user interaction data, the historical user usage data and the preset song database through a preset language model, and obtaining a target lyric semantic feature;
extracting metadata of the song from the real-time user interaction data, the historical user usage data and the preset song database through a preset data integration model, performing metadata integration, and obtaining target metadata; and
determining the target audio feature, the target lyric semantic feature and the target metadata as the multimodal music features.

18. The electronic device according to claim 16, wherein performing the search on the preset song database based on the currently playing song and the preset search algorithms and obtaining the set of candidate songs comprises:
performing multimodal music feature extraction on the currently playing song, and obtaining a current music feature;
performing a search on the preset song database based on the current music feature using a first search algorithm and a second search algorithm in the preset search algorithms, and obtaining a first set of songs and a second set of songs;
performing a search on the preset song database based on the current music feature using a third search algorithm in the preset search algorithms, and obtaining a third set of songs; wherein a search level of the third search algorithm is higher than that of each of the first search algorithm and the second search algorithm;
fusing the first set of songs and the second set of songs, and obtaining a fused set of songs; and
filtering the fused set of songs through the third set of songs, and obtaining the set of candidate songs.

19. The electronic device according to claim 13, wherein generating the dynamic queue of the set of candidate songs based on the target model and the target music feature and obtaining the set of to-be-played songs comprises:
calculating, based on the target model and the target music feature, an overall score corresponding to each candidate song in the set of candidate songs;
sorting candidate songs in the set of candidate songs according to the overall score, and obtaining a candidate song sequence;
filtering, based on a preset selection algorithm, the candidate song sequence, and obtaining a filtered candidate song sequence; and
generating, based on a preset recommendation algorithm, a dynamic queue of the filtered candidate song sequence, and obtaining the set of to-be-played songs.

20. A non-transitory computer-readable storage medium having stored thereon computer-executable instructions, wherein the computer-executable instructions, when called and executed by a processor, cause the processor to implement the following steps:
obtaining real-time user interaction data and historical user usage data of songs;
generating, based on the real-time user interaction data and the historical user usage data, a target model, wherein the target model is a model representing user preferences;
obtaining a target music feature and a set of candidate songs similar to a currently playing song; wherein the target music feature is a feature obtained by fusing multimodal music features; and
generating, based on the target model and the target music feature, a dynamic queue of the set of candidate songs, and obtaining a set of to-be-played songs.
